(19) United States
(12) Patent Application Publication
(10) Pub. No.: US 2020/0314544 A1
(43) Pub. Date: Oct. 1, 2020

(54) SUBSTRATE MATERIAL OF DIAPHRAGM AND METHOD FOR MANUFACTURING SAME

(71) Applicant: AAC Technologies Pte. Ltd., Singapore city (SG)

(72) Inventors: Ping Liang, Shenzhen (CN); Bin Zhao, Shenzhen (CN); Binbin Yang, Shenzhen (CN)

(21) Appl. No.: 16/727,975

(22) Filed: Dec. 27, 2019

(30) Foreign Application Priority Data
Mar. 26, 2019 (CN) 201910233993.X

(51) Int. Cl. H04R 7/06; B32B 7/05; B32B 27/08

(52) U.S. Cl. CPC H04R 7/06; H04R 1/02; B32B 27/08; B32B 7/05

(57) ABSTRACT

The invention discloses a substrate material and a preparation method thereof, and a diaphragm. The substrate material comprises a first adhesive layer, a second adhesive layer, a first polymer material layer made of polymer material, a second polymer material layer made of polymer material, and a porous damping material layer made of porous damping material. The porous damping material layer comprises a first side surface and a second side surface arranged opposite to each other, the first polymer material layer is glued to the first side surface through the first adhesive layer, the second polymer material layer is glued to the second side surface through the second adhesive layer. The vibration amplitude of products using the substrate material of the present invention has a smaller deviation with increasing temperature, which improves stability of product performance.

### FIELD OF THE PRESENT DISCLOSURE

The present invention relates to the field of electroacoustic devices, particularly to a substrate material of a diaphragm, and to a method for manufacturing the substrate material. The present invention further relates to a diaphragm made by the substrate material.

### DESCRIPTION OF RELATED ART

At present, materials of diaphragm are generally single-layer or composite materials such as silicone rubber, thermoplastic elastomer (TPE), thermoplastic polyurethane elastomer rubber (TPU), etc. These polymer materials have good elasticity with a small modulus, and are often used in the preparation of existing diaphragms. However, because these polymer materials are not resistant to high temperatures. When the temperature rises to a certain level (the product continues to vibrate or perform reliability experiments), in some products, the product amplitude becomes larger and larger, which causes deviations, results in product swing, then directly leads to product performance failure. FIG. 1 is the amplitude change diagram of respective vibration of 20 ms (millisecond) and 500 ms with material of diaphragm at different temperatures, 20 ms and 500 ms represent different time used to test the existing material of diaphragm in the same frequency phase interval, the longer the time, the more vibrations and the higher the product temperature. From the figure we can see the significant deviation of the vibration amplitude of same pint on the product using the existing diaphragm under the test conditions of 20 ms and 50 ms.

Accordingly, an improved material for diaphragm is desired to solve the problems mentioned above.

### SUMMARY OF THE PRESENT INVENTION

One of the major objects of the present invention is to provide a material for a diaphragm used in a speaker which can reduce the amplitude deviation under high temperature.

Another of the major objects of the present invention is to provide a method for manufacturing the substrate material to reduce the amplitude deviation under high temperature.

A further one of the major objects of the present invention is to provide a diaphragm made of the substrate material.

For achieving the objects mentioned above, the present invention provides a substrate material for a diaphragm. The substrate material includes a first adhesive layer, a second adhesive layer, a first polymer material layer made of polymer material, a second polymer material layer made of polymer material, and a porous damping material layer made of porous damping material.

The porous damping material layer comprises a first side surface and a second side surface arranged opposite to each other. The first polymer material layer is glued to the first side surface through the first adhesive layer, the second polymer material layer is glued to the second side surface through the second adhesive layer.

In addition, the first adhesive layer and/or the second adhesive layer are formed by glue solidification.

In addition, the first polymer material layer and the second polymer material layer are respectively made of at least one of silicone rubber, thermoplastic elastomer, thermoplastic polyurethane elastomer rubber, polyetheretherketone, and polyethylene terephthalate.

In addition, the materials of the first polymer material layer and the second polymer material layer are different.

In addition, the porous damping material layer is made of at least one of polyphthalamide and polyetherketone materials.

In addition, the porous damping material layer is a grid-like structure comprising many through holes.

The invention further provides a method for manufacturing the substrate material mentioned above, comprising steps of: prepare a first polymer material layer, a second polymer material layer, and a porous damping material layer, respectively; glue and fix the first polymer material layer and the second polymer material layer respectively to the first side surface and the second side surface of the porous damping material layer.

In addition, the step of gluing and fixing the first polymer material layer, the second polymer material layer with the porous damping material includes step of: apply glue on one side surface of the first polymer material layer and second polymer material layer respectively, attach the side surface of the first polymer material layer coated with glue to the first side surface, and attach the side surface of the second polymer material layer coated with glue to the second side surface; or, apply glue on the first side surface and the second side surface respectively, attach the first polymer material layer to the first side surface coated with glue, and attach the second polymer material layer to the second side surface coated with glue; or, apply glue to one side surface of the first polymer material layer; attach the side surface of the first polymer material layer coated with glue to the first side surface; apply glue on the second side surface, and then attach the second polymer material layer to the second side surface coated with glue.

The invention further provides a diaphragm made of the substrate material mentioned above.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is a vibration amplitude change schematic diagram of existing material of diaphragm when vibrating respectively 20 ms and 500 ms at different temperatures;

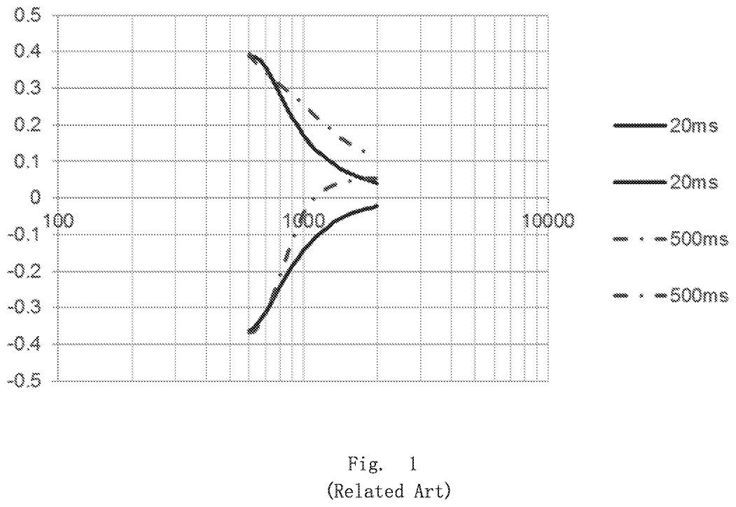

FIG. 2 is an isometric view of a substrate material in accordance with an exemplary embodiment of the present invention;

FIG. 3 is a front view of the substrate material in FIG. 1;

FIG. 4 is an exploded view of the substrate view in FIG. 1;

FIG. 5 is a vibration amplitude change schematic diagram of the substrate material provided in embodiment of the present invention vibrating respectively 20 ms and 500 ms under different temperatures;

FIG. 6 is an isometric view of a speaker using the diaphragm provided by the present invention;

FIG. 7 is a cross-sectional view of the speaker taken along line A-A in FIG. 6.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiments described hereby is only to explain the disclosure, not intended to limit the disclosure.

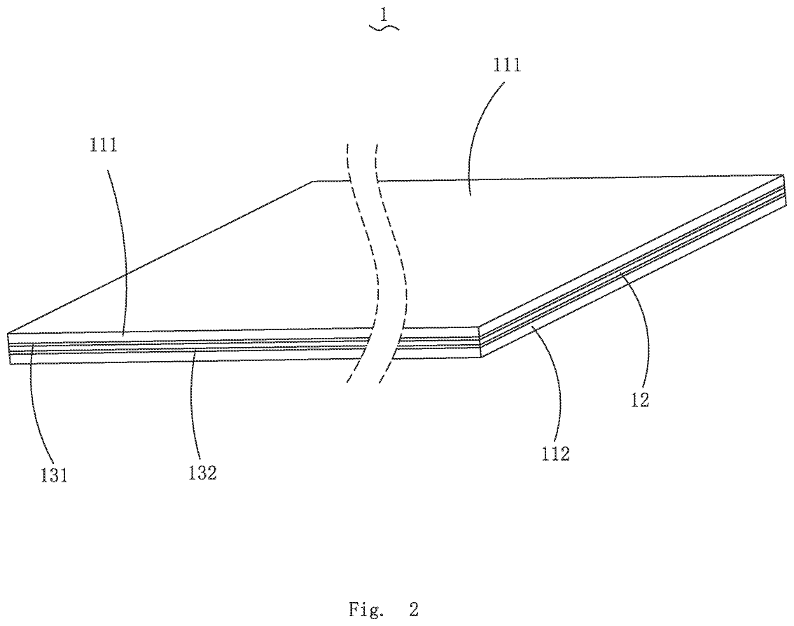

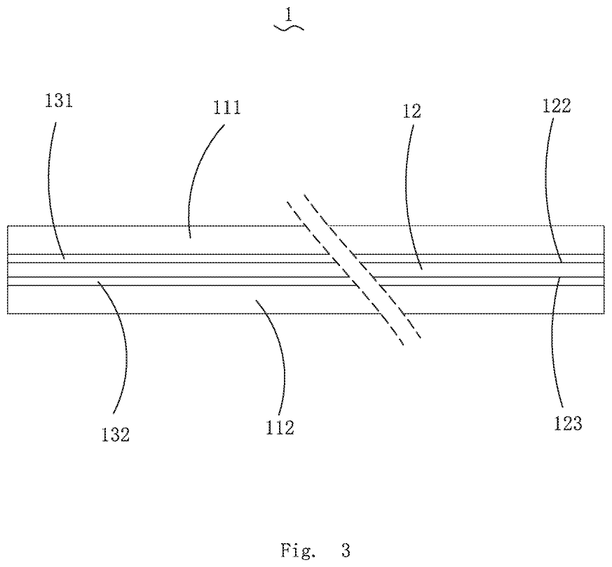

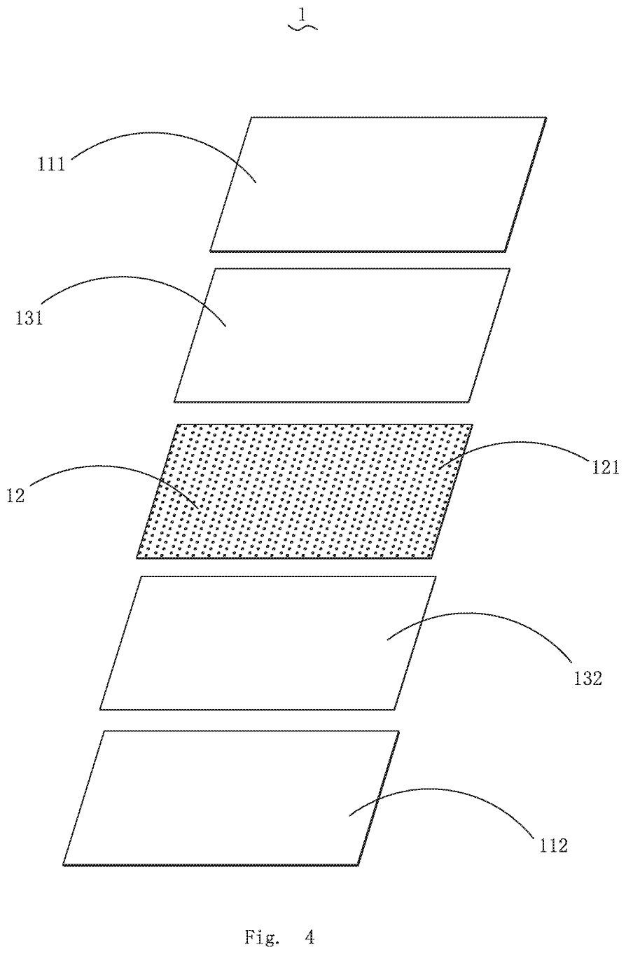

As shown in FIGS. 2-5, a substrate material 1 provided by the present invention comprises a first adhesive layer 131, a second adhesive layer 132, a first polymer material layer 111 made of polymer material, and a second polymer material layer 112 made of polymer material and a porous damping material layer 12 made of a porous damping material. The porous damping material layer 12 comprises a first side surface 122 and a second side surface 123 arranged opposite to each other. The first polymer material layer 111 is glued to first side surface 122 through first adhesive layer 131, the second polymer material layer 112 is glued to the second side surface 123 through a second adhesive layer 132. Because porous damping material layer 12 is added to substrate material 1 in this embodiment, the porous damping material has high structural strength and can restrain the contractility of polymer materials, so it can ensure that the dimensions of products made of the substrate material 1 of this embodiment remain consistent. In addition, the substrate material 1 of this embodiment can restrain and improve the variation of the properties of polymer materials under high temperature conditions. Therefore, the vibration amplitude of the products using the substrate material 1 of this embodiment such as speaker has a smaller deviation with increasing temperature, which improves the stability of the product performance.

Preferably, the first adhesive layer 131 and/or the second adhesive layer 132 are formed by glue solidification. Both the first adhesive layer 131 and the second adhesive layer 132 of the present invention are formed by applying glue and after glue solidification

Preferably, the first polymer material layer 111 and the second polymer material layer 112 are respectively made of at least one of silicone rubber, thermoplastic elastomer, thermoplastic polyurethane elastomer rubber, polyetheretherketone, polyethylene terephthalate. These high-molecular materials have relatively small elastic modulus and relatively good elasticity. The materials of the first polymer material layer 111 and the second polymer material layer 112 may be the same or different. Polymer materials with different materials are used in this embodiment. Of course, polymer materials of the same material can also be used. The substrate material 1 of which diaphragm is small at high temperature can be obtained

Preferably, the porous damping material layer 12 is made of at least one of polyphthalamide and polyetherketone material. These porous damping materials have high structural strength and can restrain the variation of properties of polymer material under high temperature conditions. In this embodiment, the porous damping material layer 12 is a grid-like structure comprising many through holes 121.

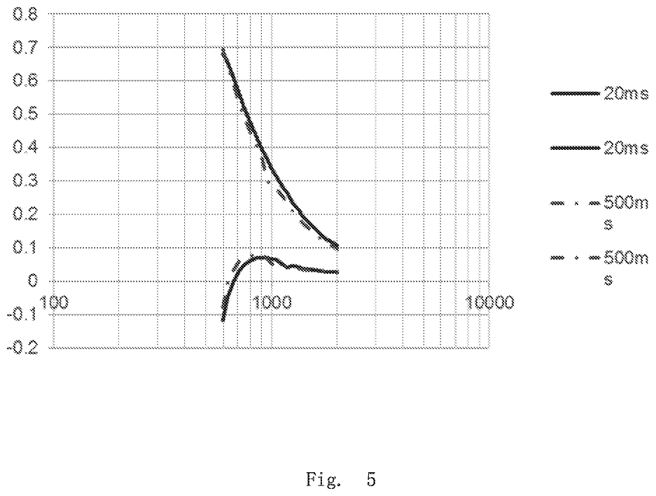

FIG. 5 is the amplitude change diagram of respective vibration of 20 ms and 500 ms with substrate material 1 provided in this embodiment at different temperatures, 20 ms and 500 ms represent different time used to test the substrate material 1 of this embodiment in the same frequency phase interval. We can see that the substrate material 1 of this embodiment has a small amplitude deviation at the same point on the product under the test conditions of 20 ms and 50 ms.

This embodiment further provides a method for preparing the above-mentioned substrate material 1, including the following steps:

Prepare the polymer material layer and the porous damping material layer 12 respectively;

Stack and bond the polymer material layer and porous damping material layer 12 together with glue to form a substrate material 1.

Preferably, the bonding methods of the first polymer material layer 111, the second polymer material layer 112 with the porous damping material layer 12 can be any of the following five ways.

The first one is to apply glue on a side surface of the first polymer material layer 111 and the second polymer material layer 112 respectively. Attach the side surface of the first polymer material layer 111 coated with glue to the first side surface 122, then press the first polymer material layer 111 to porous damping material layer 12, attach the side surface of second polymer material layer 112 coated with glue to the second side surface 123, finally, press the second polymer material layer 112 to the porous damping material layer 12.

The second way is to apply glue on one side surface of the first polymer material layer 111 and the second polymer material layer 112, attach the side surface of the first polymer material layer 111 coated with glue to the first side surface 122, attach the side surface of second polymer material layer 112 coated with glue to the second side surface 123, then the press first polymer material layer 111 and the second polymer material layer 112 to the porous damping material layer 12.

The third way is to apply glue respectively on the first side surface 122 and the second side surface 123, attach first polymer material layer 111 to the first side surface coated with glue, attach first polymer material layer 112 to the second side surface coated with glue, then press the first polymer material layer 111 and the second polymer material layer 112 onto the porous damping material layer 12.

The fourth way is to apply glue on one side surface of the first polymer material layer 111, attach the side surface of the first polymer material layer 111 coated with glue onto first side surface 122, then press the first polymer material layer 111 onto the porous damping material layer 12, then apply glue on second side surface 123, and attach the second polymer material layer 112 onto the second side surface 123 coated with glue. Finally, press the second polymer material layer 112 onto the porous damping material layer 12.

The fifth way is to apply glue on one side surface of the first polymer material layer 111, attach the side surface of the first polymer material layer 111 coated with glue onto first side surface 122, apply glue on the second side surface 123, then attach the second polymer material layer 112 onto the second side surface 123 coated with glue, then press first polymer material layer 111 and the second polymer material layer 112 onto the porous damping material layer 12.

The diaphragm provided in this embodiment is processed from the aforementioned substrate material 1. Because the above-mentioned substrate material 1 is used for processing, the vibration amplitude of the diaphragm is small with increasing temperature, so the product performance is relatively stable. The substrate material 1 is processed to form diaphragm, specifically processing operations such as cutting, stamping, molding substrate material 1 are included.

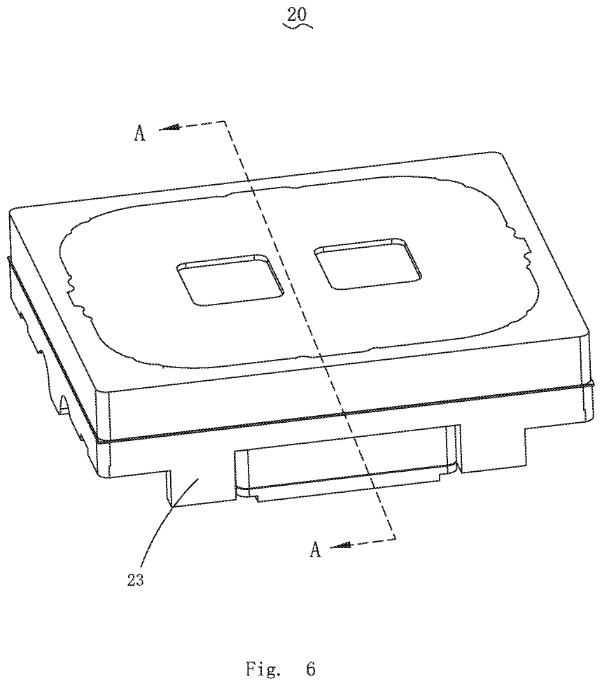

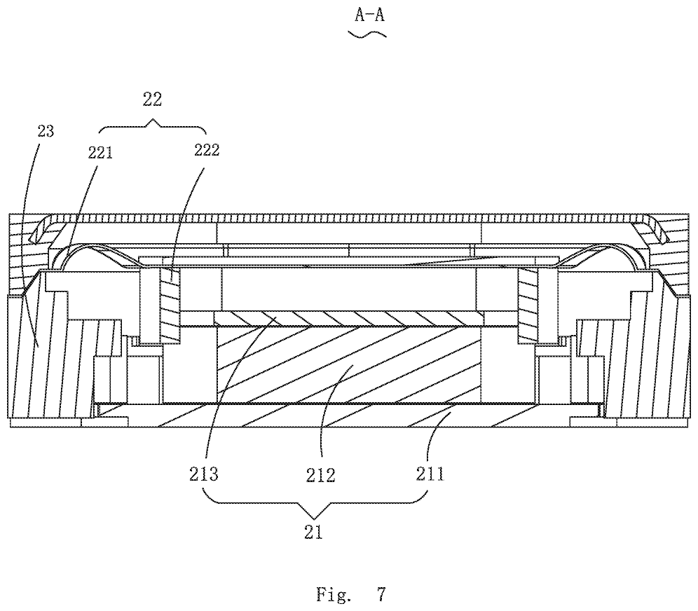

As shown in FIGS. 6-7, the present embodiment provides a speaker 20 which, comprises a magnetic circuit system 21, a vibration system 22 and a frame 23 provided with an accommodation cavity. Both the magnetic circuit system 21 and the vibration system 22 are accommodated in the accommodation cavity. The vibration system 22 comprises a diaphragm 221 connected to the top of the frame 23,

The diaphragm 221 uses the diaphragm provided in this embodiment. The first polymer material layer 111 or the second polymer material layer 112 is arranged on the side of the diaphragm 211 near the frame 23. In a preferred embodiment, a magnetic circuit system 21 comprises a magnetic frame 211 connected to the bottom of a frame 23, a permanent magnet 212 accommodated in a magnetic frame 211, and a pole plate 213 fixed on the top of a permanent magnet 212. The bottom of the permanent magnet 212 is fixed in the magnetic frame 211, the vibration system 22 comprises a diaphragm 221 connected to the top of a frame 23, a voice coil 222 arranged at the bottom of the diaphragm 221 positioned in the accommodation cavity, under the influence of the magnetic field generated by the magnetic circuit system 21, the voice coil 222 moves and drives the diaphragm 221 to vibrate up and down.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A substrate material for a diaphragm, comprising:
a first adhesive layer;
a second adhesive layer;
a first polymer material layer made of polymer material;
a second polymer material layer made of polymer material;
a porous damping material layer made of porous damping material; wherein
the porous damping material layer comprises a first side surface and a second side surface arranged opposite to each other, the first polymer material layer is glued to the first side surface through the first adhesive layer, the second polymer material layer is glued to the second side surface through the second adhesive layer.

2. The substrate material according to claim 1, wherein the first adhesive layer and/or the second adhesive layer are formed by glue solidification.

3. The substrate material according to claim 2, wherein the first polymer material layer and the second polymer material layer are respectively made of at least one of silicone rubber, thermoplastic elastomer, thermoplastic polyurethane elastomer rubber, polyetheretherketone, and polyethylene terephthalate.

4. The substrate material according to claim 3, wherein the materials of the first polymer material layer and the second polymer material layer are different.

5. The substrate material according to claim 1, wherein the porous damping material layer is made of at least one of polyphthalamide and polyetherketone materials.

6. The substrate material according to claim 2, wherein the porous damping material layer is made of at least one of polyphthalamide and polyetherketone materials.

7. The substrate material according to claim 3, wherein the porous damping material layer is made of at least one of polyphthalamide and polyetherketone materials.

8. The substrate material according to claim 4, wherein the porous damping material layer is made of at least one of polyphthalamide and polyetherketone materials.

9. The substrate material according to claim 5, wherein the porous damping material layer is a grid-like structure comprising many through holes.

10. The substrate material according to claim 6, wherein the porous damping material layer is a grid-like structure comprising many through holes.

11. The substrate material according to claim 7, wherein the porous damping material layer is a grid-like structure comprising many through holes.

12. The substrate material according to claim 8, wherein the porous damping material layer is a grid-like structure comprising many through holes.

13. A method for manufacturing the substrate material according to claim 1, comprising steps of:
preparing a first polymer material layer, a second polymer material layer, and a porous damping material layer, respectively;
gluing and fixing the first polymer material layer and the second polymer material layer respectively to the first side surface and the second side surface of the porous damping material layer.

14. The method according to claim 13, wherein the step of gluing and fixing the first polymer material layer, the second polymer material layer with the porous damping material includes step of:
applying glue on one side surface of the first polymer material layer and second polymer material layer respectively, attaching the side surface of the first polymer material layer coated with glue to the first side surface, and attaching the side surface of the second polymer material layer coated with glue to the second side surface; or,
applying glue on the first side surface and the second side surface respectively, attaching the first polymer material layer to the first side surface coated with glue, and attaching attach the second polymer material layer to the second side surface coated with glue; or,
applying glue to one side surface of the first polymer material layer; attaching the side surface of the first polymer material layer coated with glue to the first side surface; applying glue on the second side surface, and then attaching the second polymer material layer to the second side surface coated with glue.

15. A diaphragm made of the substrate material as described in claim 1.
